(19) United States
(12) Patent Application Publication
(10) Pub. No.: US 2004/0090127 A1
(43) Pub. Date: May 13, 2004

(54) Motor controller for image reading apparatus, and image reading apparatus with the same

(75) Inventor: Sueo Ueno, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/291,668

(22) Filed: Nov. 12, 2002

(51) Int. Cl. H02K 41/00; H02P 1/00

(52) U.S. Cl. 310/12; 318/135; 310/13

(57) ABSTRACT

A motor controller for an image reading apparatus including a carriage driven with the use of a DC motor is provided, which controller comprises a scale for position detection disposed along a direction, in which said carriage is driven, a sensor mounted to said carriage for detecting said scale for position detection, and a control part for enabling said DC motor to be driven based on a detection signal resulting from said sensor. Specifically, in the case where the DC motor comprises a linear motor, triangular pulses are obtained from the photosensor while the carriage runs. At a predetermined reference position, the pulse is inverted, and the inverted pulse is fed back to the motor inversely to apply the brake thereon.

### BACKGROUND OF THE INVENTION

1. Field of the Invention

The present invention relates to a motor controller for an image reading apparatus, such as an electronic copying machine, a facsimile machine, a scanner or the like, and more particularly to a motor controller for an image reading apparatus, as well as an image reading apparatus with the same, which can accomplish, with a high degree of accuracy, the positioning by controlling the operation of a motor.

2. Description of the Related Art

With respect to the control of operation of a motor for an image reading apparatus, e.g., the control of operation of a stepping motor, such a technique is known (e.g., see Japanese Patent Application KOKAI Publication No. H8-256272 as Patent Literature 1), in which technique a photo-interrupter scans black and white lines drawn at even intervals on a line chart to generate a certain width of pulse signals, based on which the degree of vibrations of a carriage is interpreted to provide for optimization of a run-up time to vibrational absorption so that an image on a color copy can be red stably without any color drift, regardless of such as each variation of a load acting on a scanner device, and changes in a load depending on frequency in use of the scanner device. FIG. 18 illustrates an arrangement that controls operation of a stepping motor, thereby controlling operation of a carriage. According to FIG. 18, it is noted that a drive shaft 1 is disposed in parallel with a driven shaft 2, with their being spaced from each other in the direction of sub-scanning and with a wire 3, to which the carriage 4 is attached, being suspended between the shafts 1 and 2 in an endless manner. The drive shaft 1 is disposed for rotational movement in cooperation with the stepping motor 5. That is, a motor drive 7 outputs a drive signal to the stepping motor 5 in response to pulses generated by a drive pulse generator 6 to cause the stepping motor 5 to be driven by a predetermined amount, thereby rotating the drive shaft 1 accordingly. The wire 3 suspended on the drive shaft 1 rotates to drive the carriage 4 while controlling a position thereof.

Although the positioning control can be carried out with ease by employing the stepping motor 5, relatively large vibrations resulting from the specific construction of the stepping motor 5 may still occur, even if the above technique is employed. Especially, in a reading apparatus, such as a color scanner, that is concerned about the impact of vibrations, an image reading accuracy may be adversely affected to a large extent by the use of the stepping motor 5. In the meantime, although a DC motor, particularly a linear motor represented by a voice coil motor, generates slight vibrations because of its construction and it is superior to the stepping motor, the prior art could not carry out the positioning control and the brake control of the DC motor with a high degree of accuracy.

### SUMMARY OF THE INVENTION

The present invention has been made in order to solve the above problems, and its object is to provide an image reading apparatus, which allows a DC motor to perform both a positioning control and a braking control with high precision, and therefore can reduce motor vibrations to a minimum, resulting in an improved accuracy of image reading.

In order to attain the above object, according to the present invention, a motor controller for an image reading apparatus including a carriage driven with the use of a DC motor is provided, which comprises a scale for position detection disposed along a direction, in which said carriage is driven; a sensor mounted to said carriage for detecting said scale for position detection; and a control part for enabling said DC motor to be driven based on a detection signal resulting from said sensor.

In the motor controller for an image reading apparatus according to the present invention, said control part includes a calculation part for calculating a position of said carriage based on said detection signal resulting from said sensor.

In the motor controller for an image reading apparatus according to the present invention, said scale for position detection has a profile, of which width to be detected changes in dimension along a sub-scanning direction, and said calculation part detects the position based on the width detected by said sensor.

In the motor controller for an image reading apparatus according to the present invention, said scale for position detection has a predetermined inclined profile so that said width to be detected changes linearly.

In the motor controller for an image reading apparatus according to the present invention, said sensor has a detecting area, of which dimension in a direction perpendicular to said inclined profile is wider than that in a direction parallel to said inclined profile.

In the motor controller for an image reading apparatus according to the present invention, said scale for position detection includes a plurality of slits formed therein at equal intervals along a sub-scanning direction, and said calculation part detects the position based on the number of pulses produced due to said slits and detected by said sensor in response to the driving of said carriage.

In the motor controller for an image reading apparatus according to the present invention, said sensor is of a light transmission type comprising a light emitter for emitting light, and a light receiver disposed in opposition to said light emitter with said scale for position detection being sandwiched therebetween, said light receiver receiving part of the light emitted by said light emitter, which was not interrupted by said scale for position detection.

In the motor controller for an image reading apparatus according to the present invention, said light receiver includes a light receiving surface, in which a slit-like opening is provided to form a higher light-sensitive area extending in a predetermined direction.

In the motor controller for an image reading apparatus according to the present invention, said sensor is of a light reflection type comprising a light emitter for emitting light, and a light receiver for receiving part of the light emitted by said light emitter, which was reflected by said scale for position detection.

In this motor controller for an image reading apparatus according to the present invention, said light receiver also includes a light-receiving surface, in which a slit-like opening is provided so as to form a higher light-sensitive area extending in a predetermined direction.

In the motor controller for an image reading apparatus according to the present invention, said DC motor is a linear motor comprising a field coil disposed along a direction of sub-scanning, and a voice coil driven in the direction of sub-scanning by the force of a magnetic field produced in cooperation with said field coil, said voice coil supporting thereon said carriage.

In the motor controller for an image reading apparatus according to the present invention, said control part comprises, as a uniform-speed drive circuit to drive said DC motor at a uniform speed, a negative feedback control circuit operable to effect a negative feedback control so that an error signal between a reference pulse for driving and said detection pulse is maintained at or below a given value.

In the motor controller for an image reading apparatus according to the present invention, said control part comprises a brake circuit operable to apply a braking action on said DC motor by effecting a negative feedback control, which feeds back said detection signal resulting from said sensor to said motor with it being reversed with respect to a reference value, when a pulse, one ahead of a target pulse corresponding to the target position, is detected.

In the motor controller for an image reading apparatus according to the present invention, said control part comprises a drive control circuit operable to drive said DC motor with accelerating speed, equal speed, and decelerating speed, a brake circuit operable to apply a braking action on said DC motor by feeding back said detection signal resulting from said position detection part to said DC motor with it being reversed with respect to a reference value, and a switching circuit operable to change over from said drive control circuit to said brake circuit or vice versa.

Furthermore, the present invention provides an image reading apparatus configured so that image reading means for optically reading an image is provided on a carriage, said apparatus comprising a DC motor for driving said carriage, a scale for position detection disposed along a direction, in which said carriage is driven, a sensor mounted to said carriage for detecting said scale for position detection, and a control part for enabling said DC motor to be driven based on a detection signal resulting from said sensor.

### DESCRIPTION OF THE DRAWINGS

FIG. 1 is a schematic diagram illustrating a drive system for a DC motor in an image reading apparatus according to the embodiment 1 of the present invention, wherein FIG. 1(A) and FIG. 1(B) show the whole structure and the position detector thereof, respectively;

FIG. 2 illustrates photosensors, wherein FIG. 2(A) and FIG. 2(B) show a transmission type photosensor and a reflection type photosensor, respectively;

FIG. 3 shows configurations of a position sensing slit, wherein FIG. 3(A) and FIG. 3(B) are views of a shield slit configuration employed in the transmission type photosensor, respectively, and FIG. 3(C) and FIG. 3(D) are views of a reflection slit configuration employed in the transmission type photosensor, respectively;

FIG. 4 shows circuit diagrams of a photosensor more specifically, wherein FIG. 4(A) and FIG. 4(B) are views showing the transmission type photosensor, respectively, and FIG. 4(C) and FIG. 4(D) are views showing the reflection type photosensor, respectively;

FIG. 5 shows relationships between a photosensor and a linearity, wherein FIG. 5(A) shows a light emitter and a light receiver, and FIG. 5(B) and FIG. 5(C) are views showing changes in linearity of a detection sensitivity due to a difference in shield plate configuration;

FIGS. 6(A) and 6(B) are views showing changes in linearity of a detection sensitivity due to a difference in light receiver configuration;

FIG. 7 is a view showing relationships between sensor output currents and voltages when the photosensor changes in position;

FIG. 8 is a block diagram of a motor operation control system;

FIG. 9 is a flow chart showing operation of a motor operation control circuit;

FIG. 10 is a schematic diagram illustrating an operation control system for a linear motor in an image reading apparatus according to the embodiment 2 of the present invention;

FIGS. 11(A) and 11(B) are different views showing the construction of the linear motor;

FIG. 12(A) is a view showing a slit plate for position detection of a voice coil motor, and FIG. 12(B) is a view showing outputs of a photosensor comprising a position detection sensor;

FIG. 13 is a view showing a construction of a control unit;

FIG. 14 is a view showing a braking circuit;

FIG. 15 illustrates a principle of operation of the braking circuit, wherein FIGS. 15(A), 15(B), 15(C) and 15(D) are views showing a noninverted output of the sensor, an inverted output of the sensor, superposed noninverted and inverted outputs thereof, and schematically showing braking operation, respectively;

FIG. 16 is a circuit diagram showing a negative feedback control circuit;

FIG. 17 shows a timing diagram including waveforms at various parts in the negative feedback control circuit; and

FIG. 18 is a view showing a prior motor drive system in a conventional image reading apparatus.

### DESCRIPTION OF THE PREFERRED EMBODIMENTS

Now, the embodiments of the present invention will be explained hereinafter using the accompanying drawings:

### Embodiment 1

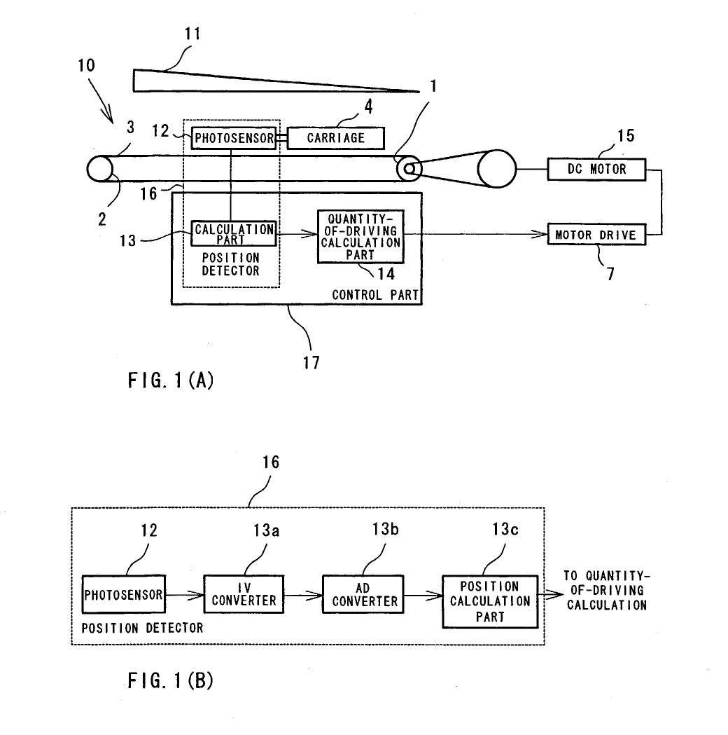

FIG. 1 shows a motor drive system for an image reading apparatus using a DC motor in the embodiment 1 according to the present invention. The embodiment 1 provides for a carriage driven by a DC motor disposed stationary. In FIG. 1, a drive shaft 1 is disposed in parallel with a driven shaft 2 and separated from the driven shaft 2 at a certain distance extending in the direction of sub-scanning of the image reading apparatus 10. A wire 3 is suspended between these shafts 1 and 2 on an endless basis with a carriage 4 being attached to the wire 3. Extending in the direction of sub-scanning of the image reading apparatus is a scale (slit plate) 11 for position detection disposed adjacent to the driven carriage 4.

The carriage 4 is associated with a photosensor 12 by which a slit(s) in the slit plate 11 is detected in order to perform the detection of a position in the direction of sub-scanning. A calculation part 13 determines the position based on a detection signal issued from the photosensor 12 performed the detection. After the position has been determined in the calculation part 13, a quantity-of-driving calculation part 14 calculates a quantity-of-driving by which the motor is to be driven, based on the calculated position-of-driving and outputs the calculated quantity-of-driving to a motor drive 7 as a feedback signal. In response to this feedback signal, the motor drive 7 applies a motor driving signal to the DC motor 15, thereby causing the DC motor 15 to be driven. When the DC motor 15 is driven in this manner, the endless wire 3 is also driven in sync therewith to cause the carriage 4 to travel accordingly. Thus, the position control of the carriage 4 is carried out. A brush motor or a brushless motor may be employed for the DC motor 15. In addition, it is noted that the photosensor 12 and calculation part 13 comprise a position detector 16, and the calculation part 13 and the quantity-of-driving calculation part 13 comprise a control part or unit 17.

FIG. 1(B) illustrates more in detail the configuration of the position detector 16 shown in FIG. 1(A). The position detector 16 includes an IV converter 13a to convert a current signal corresponding to the quantitative light received by the photosensor 12 to a voltage signal, an AD converter 13b to convert the voltage signal to a digital signal, and a position calculation part 13c to calculate the position based on the output from the AD converter 13b. It is also noted that a CPU may be employed to constitute the position calculation part, as well as the quantity-of-driving calculation part 14.

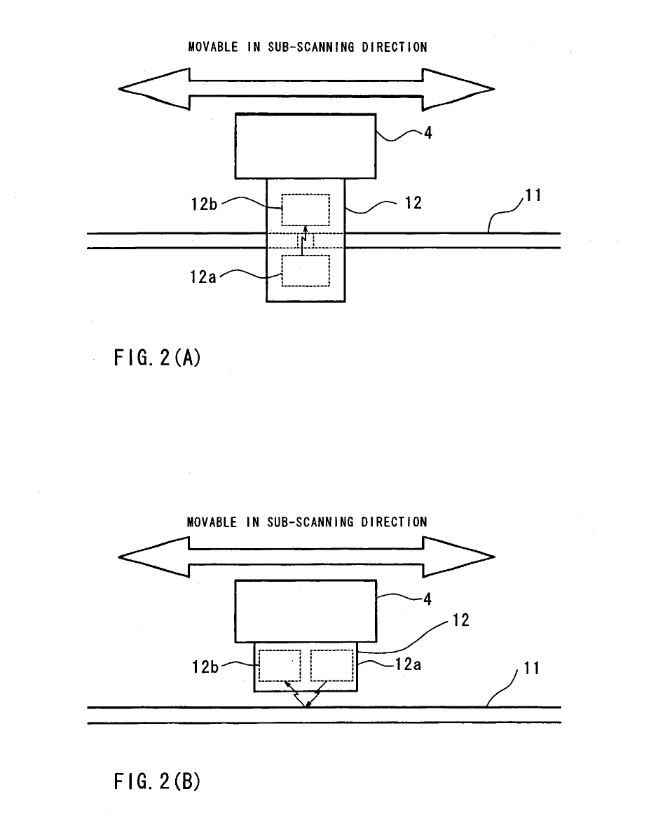

FIG. 2 illustrates physical relationships between the slit plate 11 and the photosensors 12, as well as the configuration of each photosensor 12. FIG. 2(A) shows the transmission type sensor. In this type, the photosensor 12 comprises a light emitter 12a and a light receiver 12b separated from each other through the slit plate 11. FIG. 2(B) shows the reflection type photosensor 12. In this type, the light emitter 12a and the light receiver 12b are disposed in parallel with each other and in opposition to the slit plate 11 so that the light receiver 12b can receive the light emitted by the light emitter 12a and reflected from the slit plate 11.

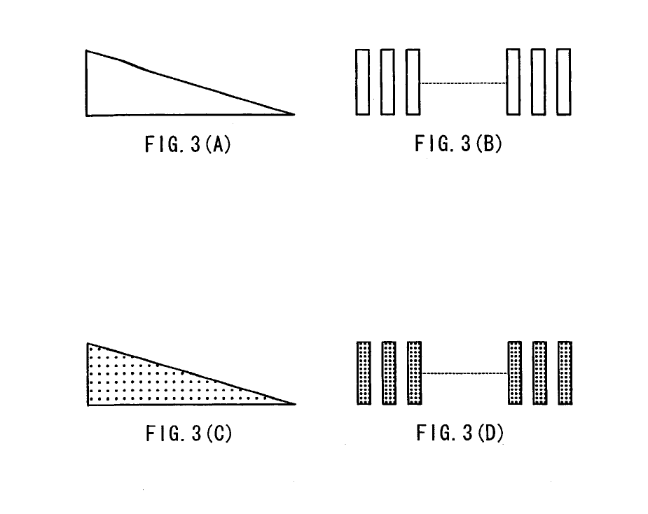

FIG. 3 shows the configurations of the slits formed in the respective slit plates. FIGS. 3(A) and 3(B) show the configurations of the slits, which may be employed in the transmission type photosensor. FIGS. 3(C) and 3(D) show the configurations of the slits, which may be employed in the reflection type photosensor. In these configurations, each of the configurations shown in FIGS. 3(A) and 3(C) has such a shape (triangular shape) that a height thereof linearly increases from one end to the other along the direction of sub-scanning. The position detector 16 detects a position in the direction of sub-scanning based on changes in amount of light received when a height for a position in the direction of sub-scanning changes. In FIGS. 3(B) and 3(D), each of slit arrangements comprises a plurality of slits disposed at fixed intervals in the direction of sub-scanning. In other words, each slit arrangement comprises an assembly of slits each having the same width. The position detector 16 detects a position by calculation in such a manner that the position detector detects the presence of each slit to change it to the amount of light received, based on which the number of slits detected, i.e., the position, is determined. These slits can be obtained by forming openings in the slit plate 11. Alternatively, a slit plate may be formed at a lower cost by providing a printed sheet including transmission and non-transmission areas or reflection and non-reflection areas on the slit plate. In this case, a glass plate may be printed.

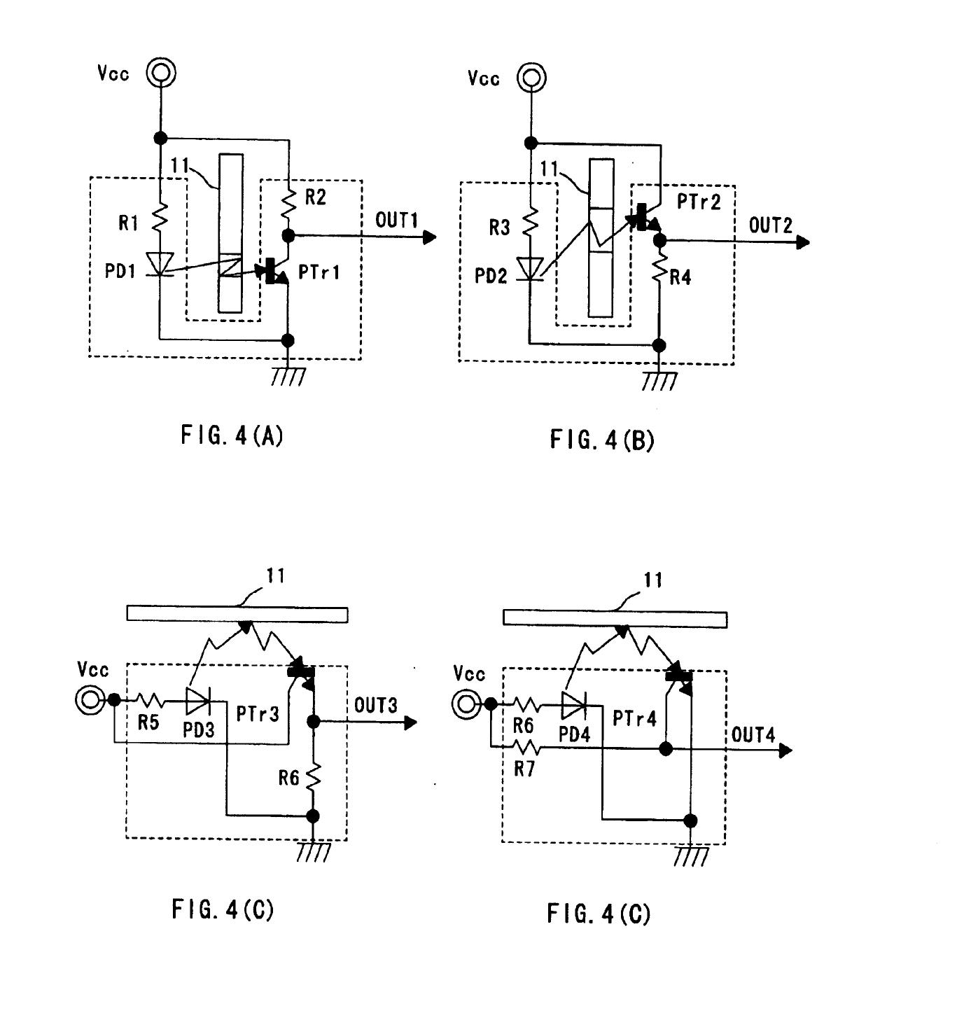

FIG. 4 shows circuit diagrams illustrating configurations of a position detector, wherein FIG. 4(A) and FIG. 4(B) are the circuit diagrams in the case where the position detector is composed of the transmission type sensor, and FIG. 4(C) and FIG. 4(D) are the circuit diagrams in the case where the position detector is composed of the reflection type sensor. In the transmission type sensor of FIG. 4(A), when light emitted from a photodiode PD1 is received in a phototransistor PTr1 after passing through a slit in the slit plate, its output voltage OUT1 changes dependent on an amount of light received. For example, the output voltage becomes minimum, e.g., null when the amount of light received is maximum.

In the transmission type sensor of FIG. 4(B), when light emitted from a photodiode PD2 is received in a phototransistor PTr2 after passing through a slit in the slit plate, its output voltage OUT2 changes dependent on an amount of light received. For example, the output voltage becomes maximum, e.g., Vcc, when the amount of light received is maximum.

In the reflection type sensor of FIG. 4(C), when light emitted from a photodiode PD3 is received in a phototransistor PTr3 after reflected by a reflection slit of the slit plate, its output voltage OUT3 changes dependent on an amount of light received. For example, the output voltage becomes maximum, e.g., Vcc, when the amount of light received is maximum.

In the reflection type sensor of FIG. 4(D), when light emitted from a photodiode PD4 is received in a phototransistor PTr4 after reflected by a reflection slit of the slit plate, its output voltage OUT4 changes dependent on an amount of light received. For example, the output voltage becomes minimum, e.g., null when the amount of light received is maximum.

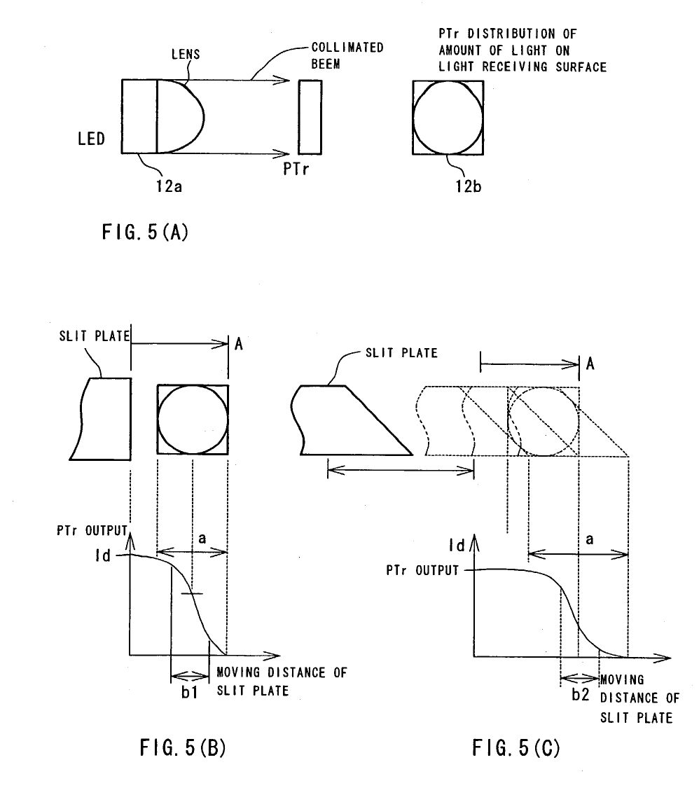

FIG. 5 show relationships between the configuration of the slit plate (photointerrupter) shown in FIGS. 3(A) and 3(B) and linearity. Where as shown in FIG. 5(A), the light transmission surface of the light emitter 12a is circular, the collimated beam is transmitted through the whole light transmission surface, and the light receiving surface of the light receiver 12b is circular, and where as shown in FIG. 5(B), the end of the slit plate is perpendicular to the direction of sub-scanning, a range “b” in which the linearity can be established becomes narrower than the diameter of the light receiving surface. It is noted that a range “a” in the drawing is a range in which an amount of light received may be variable. Furthermore, as shown in FIG. 5(C), where the dimension of the slit plate at its end in the direction of its height increases linearly as shown in FIGS. 3(A) and 3(C), a range “b2” in which the linearity can be established is made wider than a range “b1”.

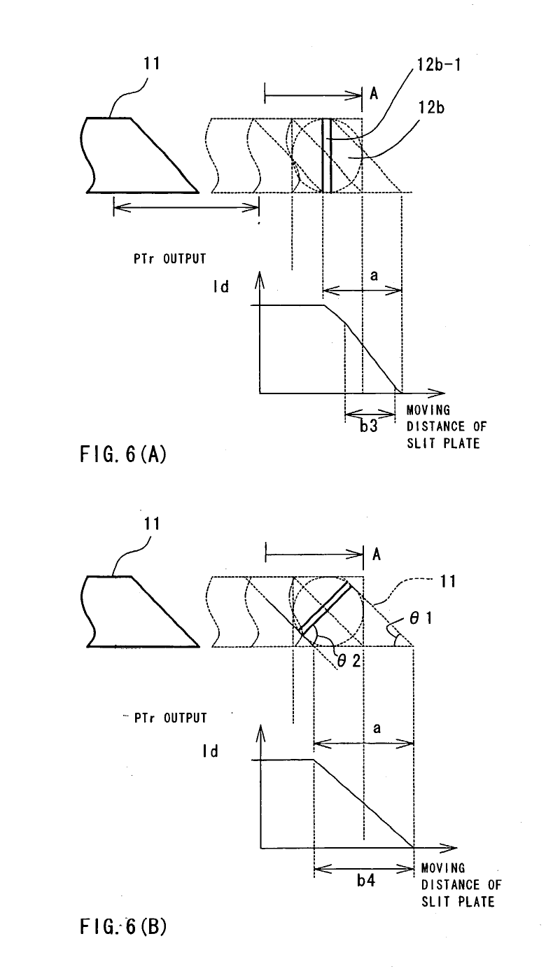

Furthermore, in the case where, as shown in FIGS. 6(A) and 6(B), the light receiving surface of the light receiver 12b is partially opened or slitted (surrounded with shield) to form a slit 12b-1, a range in which the linearity can be established is made wider than that of FIG. 5 as shown at “b3” and “b4”. Furthermore, where the inclination of the slit covering the light receiving surface is set to square to the inclination of the slit plate as shown in FIG. 6(B), a maximum range of linearity can be attained (b4>b3) at

θ1=90−θ2

thus increasing the sensitivity level and accordingly the accuracy of position detection.

Consequently, in the embodiment 1, when the slit plates as shown in FIGS. 3(A) and 3(B) are employed, the light receiving surface is adapted to be composed of a slit having an inclination perpendicular to that of the slit plate at its end. This can be easily attained by covering the light-receiving surface of the light receiver with a shield formed with such a slit.

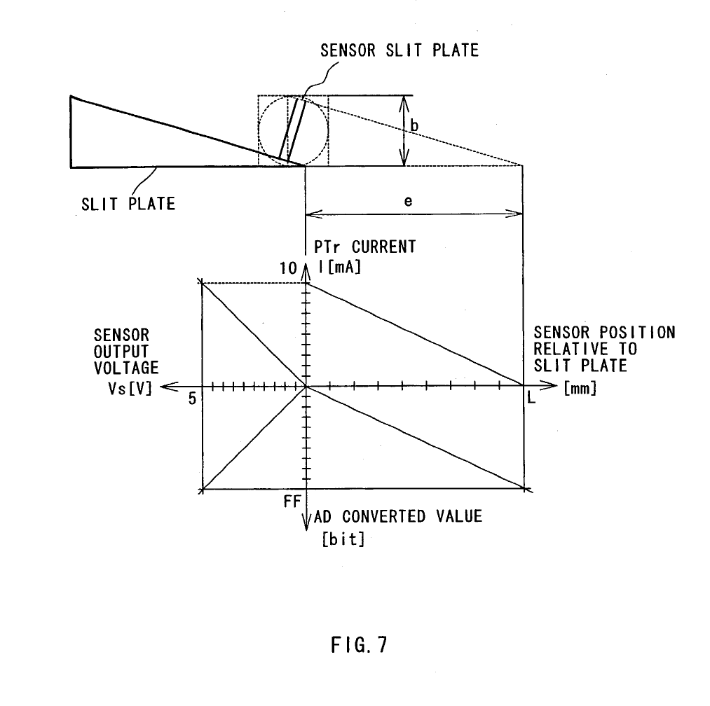

FIG. 7 is a view illustrating relationships between positions and detection signals according to the position detector having the configuration shown in FIG. 6(B). According to FIG. 7, the length “e” of the slit plate is dependent on a size of manuscript for reading, e.g., about 500 mm in an A-3 size reading apparatus. Now, assuming that the carriage 4 moves for a distance “e” from one end to the other, the sensor output is 0 mA when the whole surface of the light receiver, e.g., in the transmission type sensor is shielded by the slit plate 11. When the carriage 4 moves so as to gradually decrease an amount of shielding by the slit plate 11, the sensor output current also gradually increases. When the shielding by the slit plate 11 reaches zero and the whole surface of the light receiver 12b can receive the light, the sensor output current is 10 mA. In this regard, it is understood that the sensor output current is proportional to the travel distance of the carriage 4 and therefore a current intensity can be considered as position information.

In the meantime, an output current of the photosensor 12 is converted by optical/electrical conversion to a voltage with using a resistance of e.g. 5 kΩ, and then 10 mA×5 kΩ=5V. A travel distance of the carriage is 500 mm. By incorporating the converted voltage into the calculation system, it is made possible to control the operation of the motor.

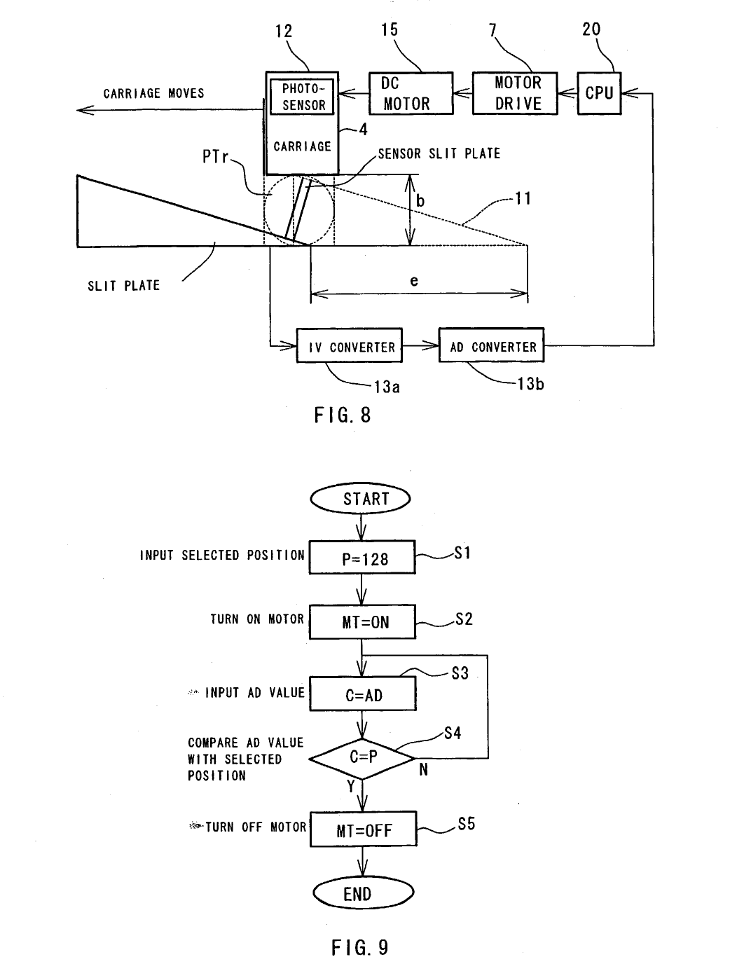

FIG. 8 is a block diagram illustrating a motor drive system by way of example only. The motor drive system shown in FIG. 8 includes a photosensor 12 attached to the carriage 4, an IV converter 13a to convert a sensor current signal from the photosensor 12 to a voltage signal, an AD converter 13b to convert the voltage signal to a digital signal, an AD converter 13b to perform the AD conversion of the voltage signal obtained from the IV converter 13a, a CPU 20 constituting a position calculation part to incorporating therein a digital voltage signal converted by the AD converter 13b for position calculation, and a motor drive 7 to drive a DC motor 15 at the motor drive command of the CPU 20 based on the position calculated by the CPU 20.

For the AD converter 13b, when it is desired to realize an accuracy of e.g., 600 dpi, a 14-bit AD converter may be adaptable to it, as a resolution is 500 mm/0.0423 mm=11820.

A typical operation for driving the carriage by such a motor drive system will now be explained with reference to the flowchart shown in FIG. 9. For example, the carriage 4 is specified to a predetermined position (e.g., a digital position P=128) based on size of a read image (at step S1). After the DC motor 15 is turned on (at step S2), the CPU 20 reads from the AD converter an actual position as a digital position C based on the detection signal from the position detector (at step S3). The value C is compared with the value P and the DC motor 15 continues to operate until the value C reaches the value P (at steps S4N and S3). At the time when the value C reached the value P, the motor is turned off (at steps S4Y and S5), thus completing the drive control procedures.

### Embodiment 2

Although in the embodiment 1 explained above, the carriage is driven by the motor disposed in the fixed position, the embodiment 2 illustrates such a configuration that the carriage 4 is adapted to move upon the operation of a voice coil motor 15A as a linear motor. In this configuration, a slit plate with slits each having a shape shown in FIG. 3(B) or 3(D) is preferably employed for the slit plate 11.

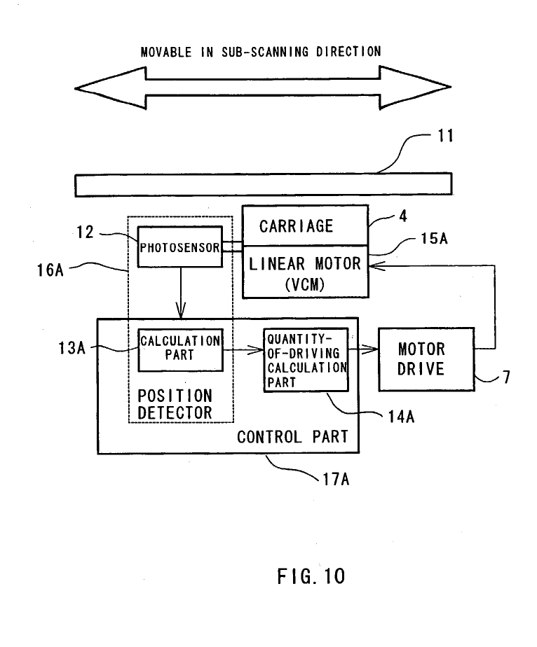

FIG. 10 is a view showing the entire configuration of an alternative motor control system utilizing a linear motor (voice coil motor). In this configuration, the carriage 4 is attached to the voice coil to travel in unison with the voice coil. The carriage 4 is provided with the photosensor 12 as in the embodiment 1 to detect slits formed in a scaler (slit plate) 11 disposed adjacent to the carriage 4 so as to extend along the direction of sub-scanning thereof. Calculation part 13A counts each slit to detect a position of the carriage relative to a reference position by adding or subtracting the number of detected slits. The motor drive 7 continues to operate the voice coil motor 15A until the carriage reaches the desired position and a stop command is issued to the motor drive to stop the operation thereof when it reaches the desired position. In this manner, the position control of the carriage 4 can be executed.

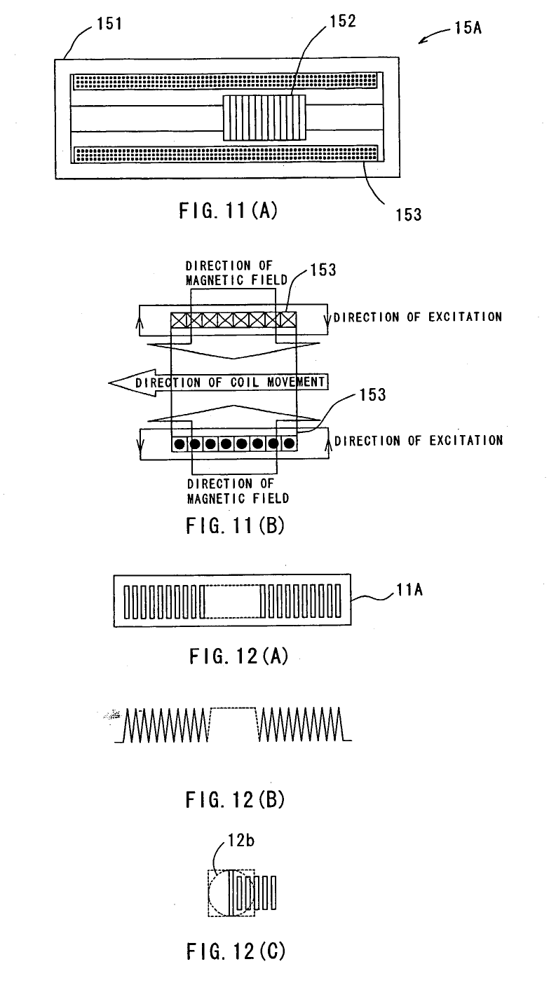

FIG. 11 structurally shows the voice coil motor. The voice coal motor 15A is of a known configuration comprising a voice coil 152 movable on a yoke 151 in the direction of sub-scanning, and a field coil 153 interacting with a magnetic field generated by the voice coil 152 causing the latter to move in the direction of sub-scanning. A current flowing through the voice coil 152 may be supplied from e.g. the motor drive 7. A current flowing through the field coil 153 may be e.g. a constant current.

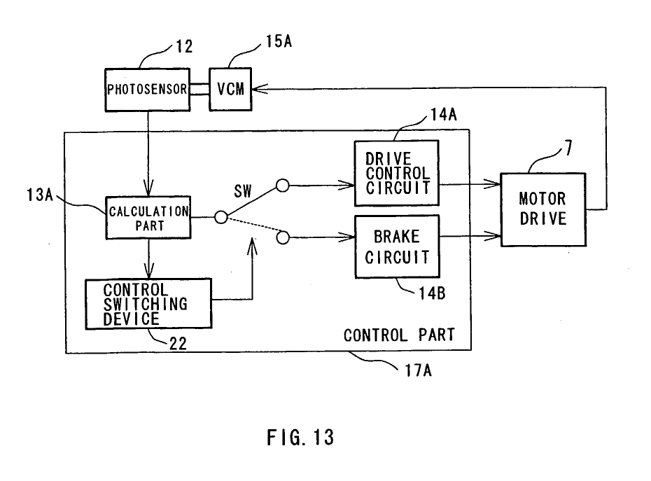

FIG. 12(A) shows a slit plate 11A provided in the side of the carriage. In this case, each detection signal obtained from the light receiver 12b of the photosensor 12 is of a triangular shape, i.e., a triangular pulse as shown in FIG. 12(B). As seen in FIG. 12(C), the light receiver 12b of the photosensor is of a rectangular shape of which length extending along the slit of the slit plate 11A is longer than the slit.

When the voice coil motor 15A is employed, the position control of the carriage 4 (drive control of the motor) may be carried out in such a manner that, while the voice coil motor 15A is accelerated from a reference position (or initial position) and continues to be driven at a constant speed to move the carriage 4, an actual position is detected by adding or subtracting the number of triangular shapes (pulses) of FIG. 12(B) detected by the position detector 16A, and then a deceleration control is commenced at the point of time where the carriage 4 in the actual position will reach a target position if the predetermined number of pulses are counted. In addition, a braking operation will start when the number of remaining slits to be detected until, e.g., the target position is attained reaches to a preset number (e.g., “1”).

The arrangement therefore is shown in FIG. 13 by way of example. In this case, the controller comprises the photosensor 12 serving to detect the slits as described above, a calculation part 13A determining a control mode based on the slit detection signals from the photosensor 12, an operation or drive control circuit 14A operable to control acceleration motion and uniform motion based on instructions from the calculation part until the detection number of slits remaining to attain the target position, which is calculated by the calculation part 13A, reaches to a predetermined number and operable to control deceleration motion based on instructions from the calculation part after the detection number of slits remaining to attain the target position, which is calculated by the calculation part 13A, reached the predetermined number and before reached the set value (e.g., “1”), a control switching device(and a switch) 22 operable to switch from motion control mode to brake control mode when the detection number of slits remaining to attain the target position, which is calculated by the calculation part 13A, reaches to the preset number, and a brake circuit 14B operable to perform a brake control based on the instruction from the calculation part 13A after the change-over. The outputs of these operation control circuit 14A and brake circuit 14B are inputted into the motor drive 7.

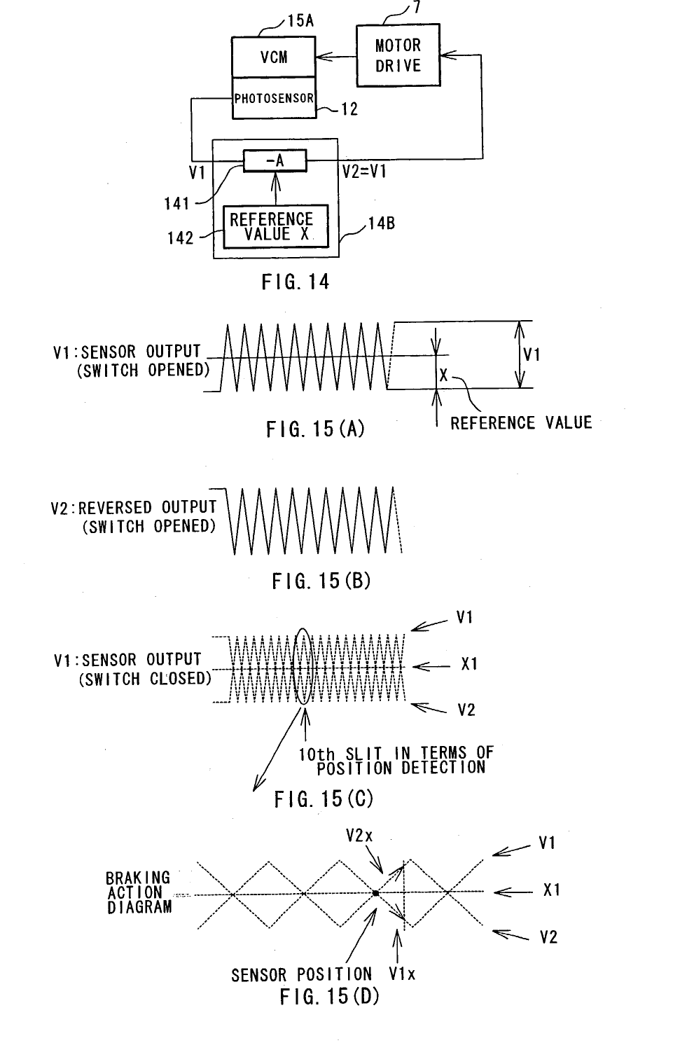

FIG. 14 shows the brake circuit 14B employed to perform a braking action when the voice coil motor 15A is in use. FIG. 15 shows views for explaining the principle of the braking action. The brake circuit 14B shown in FIG. 14 corresponds to a circuit of FIG. 13 which is formed when the switch SW is connected to the brake circuit 14B. As shown in FIG. 15, the brake circuit may comprise an inverting amplifier circuit 141 serving to amplify the output of the photosensor 12 with it being inverted relative to a reference value X stored in a register 142. More specifically, the inversion is carried out by multiplying the output of the photosensor 12 by a negative constant and then feeding back the product to the motor drive 7. As such, the control target can be converged to the reference value X. If an operator intends to drive the motor e.g. by hand, the output signal of the photosensor 12 will increase along the direction of the arrow V1X; however, as the signal fed back to the motor drive 7 serves to control the motor by means of V2 inverted from V1, the motor is caused to operate in the direction of the arrow V2X contrarily to the arrow V1X, with the result that the motor maintains the present photosensor position. Thus, the motor tends to be remained unaltered as if brake was applied on the motor even when it is driven in the opposite direction or in the normal direction.

In the operation control circuit 14A, the constant-speed control can be realized by executing negative feedback control with a PLL control loop.

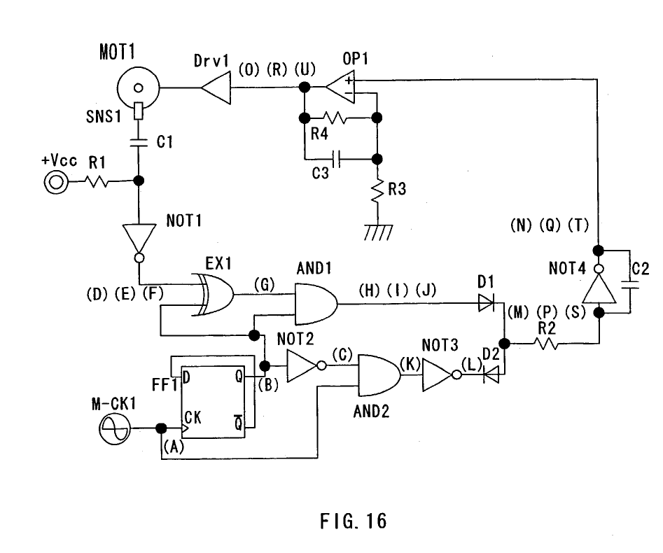

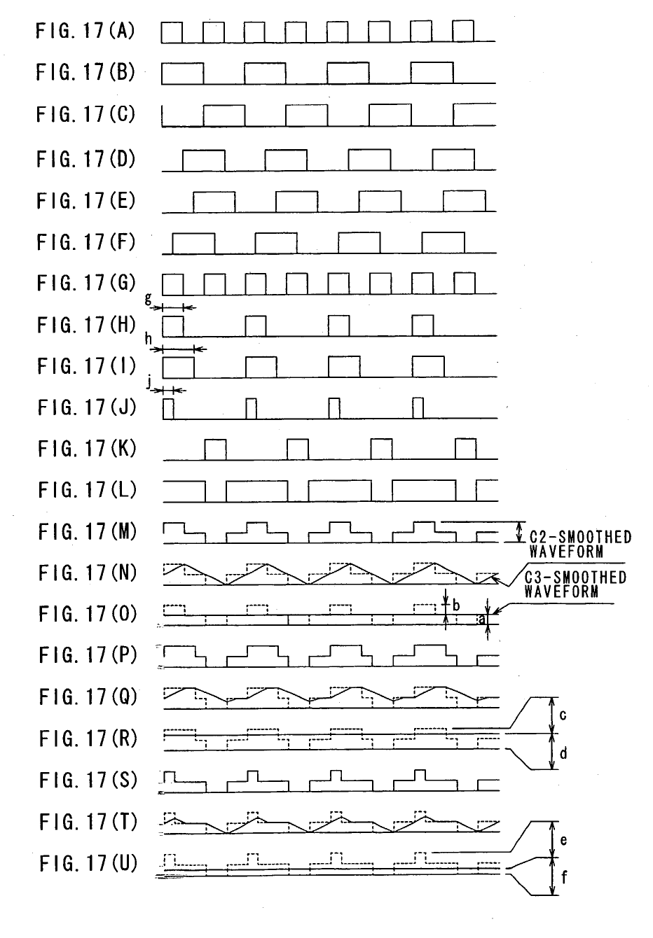

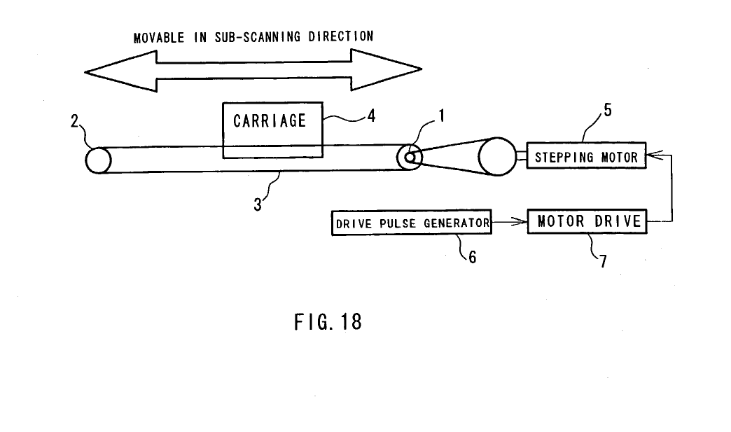

FIG. 16 shows one structural example of the constant-speed control circuit, and FIG. 17 shows a timing diagram including waveforms at various parts thereof. In the drawing, reference characters R and C represent a resistor and a capacitor, respectively. Waveform (A) in the drawing shows master clocks (M-CK) as a reference pulse for operation control. The negative feedback control is carried out with the target of maintaining an error signal between the clock and sensor output signals less or equal a predetermined level. Now, assuming that the targeted error corresponds to one clock, the stationary error of the sensor output becomes one clock as shown in (D) when the control is in a steady state. At this time, a difference signal between the sensor output and the dividing clock from an EX-OR circuit has a width of “g” as shown in (H) corresponding to one clock. The difference signal is inputted as a plus (+) signal into a demodulator circuit where it is combined with a minus (−) signal comprising the width of “g” of one clock signal with the use of a reference signal of 2.5V, with the result that a combined signal having a waveform shown in (M) can be obtained. If the combined signal is fed through a smoothing circuit, a smoothed triangular waveform as shown in (N) can be obtained, as the combined signal has uniform plus (+) and minus (−) waveforms on the opposite plus (+) and minus (−) sides of 2.5V. This is further smoothed to obtain a waveform having a strength on the average of 2.5V. If the averaged signal is fed back inversely as a motor drive signal, the actual state can be maintained as 2.5V is the reference value.

If the motor rotational speed slightly decreases to the extent that the difference between the dividing clock and the sensor output increases as shown at “h” in (I), the smoothed signal is increased in excess of 2.5V as in (P). If it is fed back inversely as the motor drive signal, then the motor frequency increases so that the error signal becomes narrower than a width of “j” in (J), eventually approaching the width of “g” in (H). Thus, the negative feedback can be counterbalanced.

In contrast, if the motor rotational speed slightly increases to the extent that the difference or error between the dividing clock and the sensor output decreases as shown at “j” in (J), the smoothed signal is lowered below 2.5V as shown in (U). If it is fed back inversely as the motor drive signal, then the motor frequency decreases so that the error signal becomes wider than the width of “j” in (J), eventually approaching the width of “g” in (H). Thus, the negative feedback amount can be counterbalanced.

It will be understood that the acceleration and the deceleration can be carried out by transferring a drive pulse as a basis for a motor speed into high- and low frequency regions, respectively.

What is claimed is:

1. A motor controller for an image reading apparatus including a carriage driven with the use of a DC motor, said motor controller comprising:
a scale for position detection disposed along a direction, in which said carriage is driven;
a sensor mounted to said carriage for detecting said scale for position detection; and
a control part for enabling said DC motor to be driven based on a detection signal resulting from said sensor.

2. A motor controller for an image reading apparatus as set forth in claim 1, wherein:
said control part includes a calculation part for calculating a position of said carriage based on said detection signal resulting from said sensor.

3. A motor controller for an image reading apparatus as set forth in claim 2, wherein:
said scale for position detection has a profile, of which width to be detected changes in dimension along a sub-scanning direction, and said calculation part detects the position based on the width detected by said sensor.

4. A motor controller for an image reading apparatus as set forth in claim 3, wherein:
said scale for position detection has a predetermined inclined profile so that said width to be detected changes linearly.

5. A motor controller for an image reading apparatus as set forth in claim 4, wherein:
said sensor has a detecting area, of which dimension in a direction perpendicular to said inclined profile is wider than that in a direction parallel to said inclined profile.

6. A motor controller for an image reading apparatus as set forth in claim 2 wherein:
said scale for position detection includes a plurality of slits formed therein at equal intervals along a sub-scanning direction, and said calculation part detects the position based on the number of pulses produced due to said slits and detected by said sensor in response to the driving of said carriage.

7. A motor controller for an image reading apparatus as set forth in claim 2 wherein:
said sensor is of a light transmission type comprising a light emitter for emitting light, and a light receiver disposed in opposition to said light emitter with said scale for position detection being sandwiched therebetween, said light receiver receiving part of the light emitted by said light emitter, which was not interrupted by said scale for position detection.

8. A motor controller for an image reading apparatus as set forth in claim 7 wherein:
said light receiver includes a light receiving surface, in which a slit-like opening is provided to form a higher light-sensitive area extending in a predetermined direction.

9. A motor controller for an image reading apparatus as set forth in claim 2 wherein:
said sensor is of a light reflection type comprising a light emitter for emitting light, and a light receiver for receiving part of the light emitted by said light emitter, which was reflected by said scale for position detection.

10. A motor controller for an image reading apparatus as set forth in claim 9 wherein:
said light receiver includes a light receiving surface, in which a slit-like opening is provided so as to form a higher light-sensitive area extending in a predetermined direction.

11. A motor controller for an image reading apparatus as set forth in claim 2 wherein:
said DC motor is a linear motor comprising a field coil disposed along a direction of sub-scanning, and a voice coil driven in the direction of sub-scanning by the force of a magnetic field produced in cooperation with said field coil, said voice coil supporting thereon said carriage.

12. A motor controller for an image reading apparatus as set forth in claim 4 wherein:
said control part comprises, as a uniform-speed drive circuit operable to drive said DC motor at a uniform speed, a negative feedback control circuit operable to effect a negative feedback control so that an error signal between a reference pulse for driving and said detection pulse is maintained at or below a given value.

13. A motor controller for an image reading apparatus as set forth in claim 4 wherein:
said control part comprises a brake circuit operable to apply a braking action on said DC motor by effecting a negative feedback control, which feeds back said detection signal resulting from said sensor to said motor with it being reversed with respect to a reference value, when a pulse, one ahead of a target pulse corresponding to a target position, is detected.

14. A motor controller for an image reading apparatus as set forth in claim 4 wherein:
said control part comprises a drive control circuit operable to drive said DC motor with accelerating speed, equal speed, and decelerating speed, a brake circuit operable to apply a braking action on said DC motor by feeding back said detection signal resulting from said position detection part to said DC motor with it being reversed with respect to a reference value, and a switching circuit operable to change over from said drive control circuit to said brake circuit or vice versa.

15. An image reading apparatus configured so that image reading means for optically reading an image is provided on a carriage, said apparatus comprising:
a DC motor for driving said carriage;
a scale for position detection disposed along a direction, in which said carriage is driven;
a sensor mounted to said carriage for detecting said scale for position detection; and
a control part for enabling said DC motor to be driven based on a detection signal resulting from said sensor.
